(19) United States
(12) Patent Application Publication
(10) Pub. No.: US 2003/0214523 A1
(43) Pub. Date: Nov. 20, 2003

(54) Method and apparatus for decoding ambiguous input using anti-entities

(76) Inventor: Kuansan Wang, Bellevue, WA (US)

Correspondence Address: Theodore M. Magee, WESTMAN CHAMPLIN & KELLY, International Centre, 900 South Second Avenue, Suite 1600, Minneapolis, MN, 55402-3319, US

(21) Appl. No.: 10/147,673

(22) Filed: May 16, 2002

(51) Int. Cl. G09G 5/00

(52) U.S. Cl. 345/700

(57) ABSTRACT

A method and apparatus are provided for interacting with a user on a computer system. Initially, the user identifies an entity that the user does not want. In response, an anti-entity value is set based on the identified entity. Using the anti-entity value, later ambiguous input from the user is clarified by reducing the likelihood that the user is referring to the entity represented by the anti-entity value.

### BACKGROUND OF THE INVENTION

The present invention relates to methods and systems for defining and handling user/computer interactions. In particular, the present invention relates to systems that allow ambiguous input from a user.

In most computer systems, users interact with the computer by entering command text or selecting icons. This type of input is directly recognizable by the computer and thus there is no ambiguity as to the value of the input. In other words, the computer does not have to form a guess as to the value of the input but instead knows the value with absolute certainty.

In other computer systems, however, the user input is not known with certainty because the computer must perform one or more recognition steps to translate the input into values that the computer can manipulate. Examples of such inputs include speech, natural language text, and handwriting.

Because recognition is not perfect, there is some uncertainty in the values identified from the input. Under some systems, this uncertainty is resolved by asking the user clarification questions. When a user positively selects an item during clarification, most systems are able to record the selection and use it in future interactions with the user. However, systems of the past have not kept track of options that the user explicitly rejects. As a result, when there is an ambiguity in a later input, the system may present a previously rejected option to the user during clarification. This makes it seem as if the system is ignoring the information that the user is providing and thus makes the system less than ideal.

As such, a computer interaction system is needed in which options that are rejected by a user are utilized by the system to determine how to resolve an ambiguity in a later input.

### SUMMARY OF THE INVENTION

A method and apparatus are provided for interacting with a user on a computer system. Initially, the user identifies an entity that the user does not want. In response, an anti-entity value is set based on the identified entity. Using the anti-entity value, later ambiguous input from the user is clarified by reducing the likelihood that the user is referring to the entity represented by the anti-entity value.

### BRIEF DESCRIPTION OF THE DRAWINGS

FIG. 1 is a general block diagram of a personal computing system in which the present invention may be practiced.

FIG. 2 is a block diagram of a dialog system of the present invention.

FIG. 3 is a flow diagram for a dialog method under the present invention.

FIG. 4 is a flow diagram of a method of expanding discourse semantic structures under one embodiment of the present invention.

### DETAILED DESCRIPTION OF ILLUSTRATIVE EMBODIMENTS

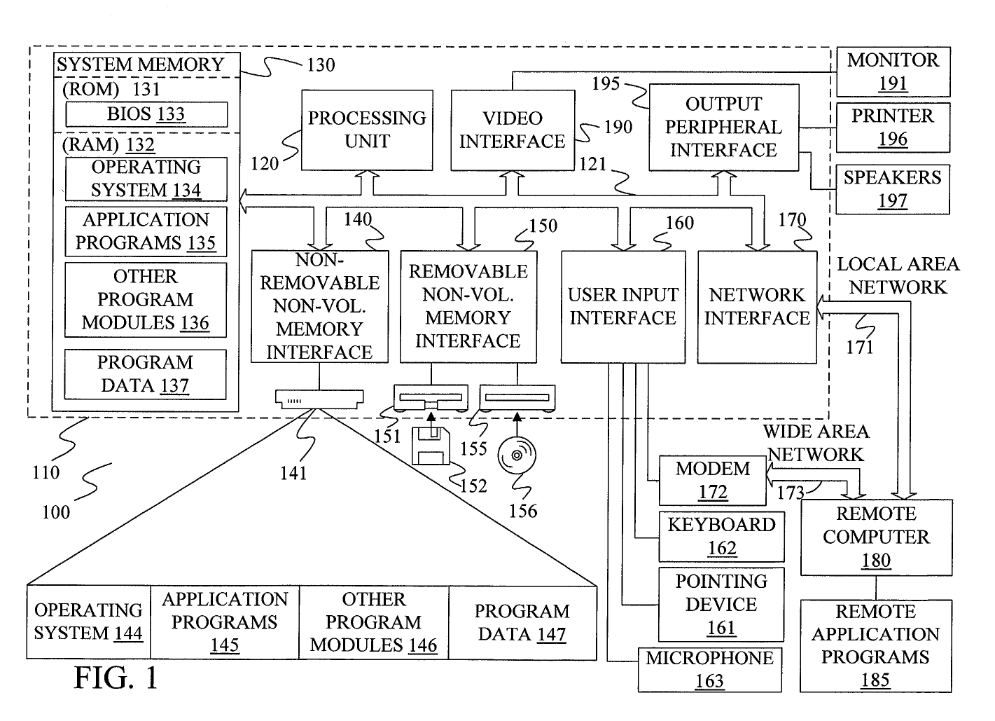

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

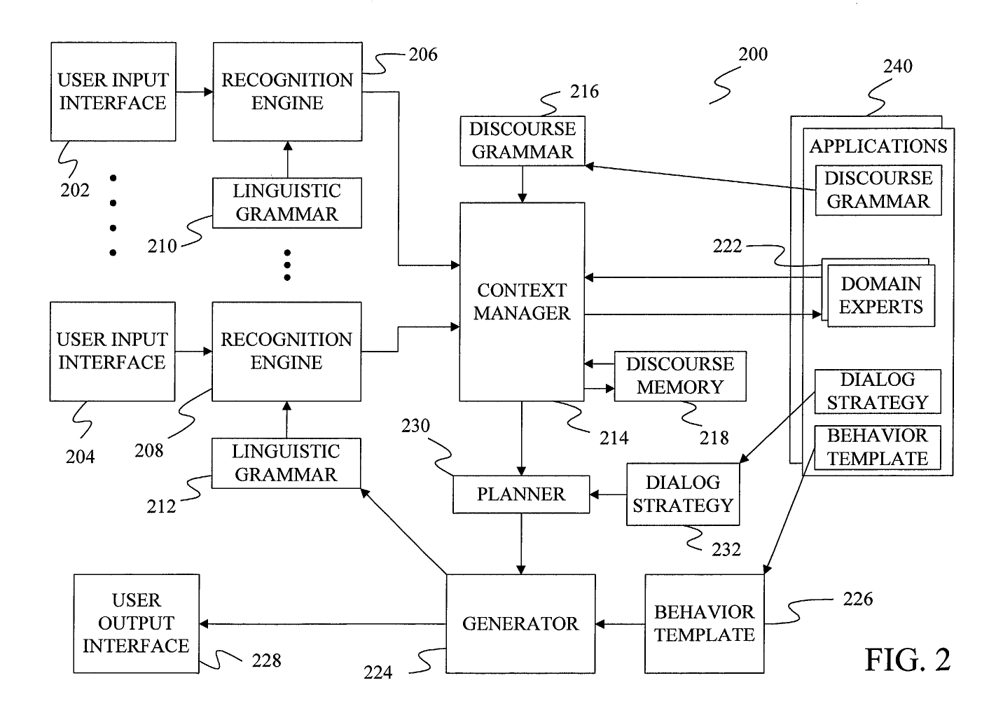

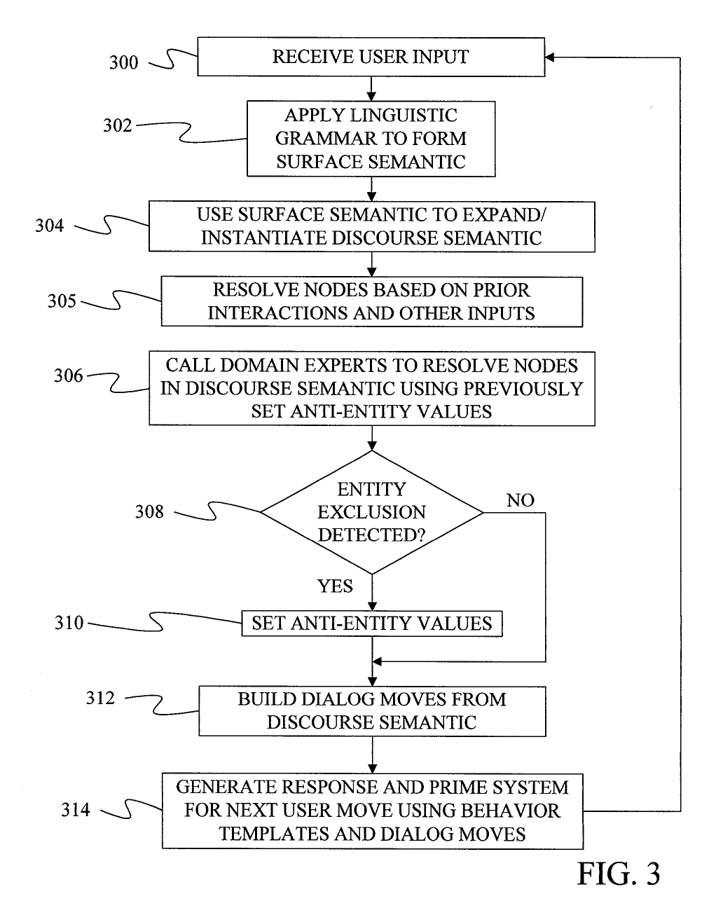

FIG. 2 provides a block diagram of a dialog system in which embodiments of the present invention may be practiced. FIG. 2 is described below in connection with a dialog method shown in the flow diagram of FIG. 3.

Under one embodiment of the invention, the components of FIG. 2 are located within a personal computer system, such as the one shown in FIG. 1. In other embodiments, the components are distributed across a distributed computing environment and connected together through network connections and protocols. For example, the components could be distributed across an intranet or the Internet.

At step 300 of FIG. 3, dialog system 200 of FIG. 2 receives input from the user through a plurality of user interfaces 202, 204. Examples of user input interfaces include a speech capture interface capable of converting user speech into text, a keyboard capable of capturing text commands and natural language text, and a pointing device interface capable of converting input from a pointing device such as a mouse or track ball into text. The present invention is not limited to these particular user input interfaces and additional or alternative user input interfaces may be used with the present invention including handwriting interfaces.

Each user input interface is provided to a surface semantic parser. In FIG. 2, a separate parser 206, 208 is provided for each user input interface. In other embodiments, a single semantic parser receives input from each of the user input interfaces.

At step 302, surface semantic parsers 206, 208 utilize device specific rules (linguistic grammars for speech and typed inputs) 210, 212, respectively, to convert the input from the user interface into a surface semantic structure. In particular, semantic parsers 206, 208 parse the input from the user interface by matching the input to one or more parse structures defined by the linguistic grammar. In the linguistic grammar, each parse structure is associated with a semantic output structure that is generated when the input matches the parse structure.

Under one embodiment, the linguistic grammar is defined using a speech text grammar format (STGF) that is based on a context-free grammar. Under this embodiment, the grammar is represented in a tagged language format extended from XML. The grammar consists of a set of rules that are defined between <rule> tags. Each rule describes combinations of text that will cause the rule to match an input text segment. To allow for flexibility in the definition of a rule, additional tags are provided. These tags include <o> tags that allow the text between the tags to be optional, <list> tags that define a list of alternatives with each alternative marked by a <p> tag wherein if any one of the alternatives matches, the list is considered to match, and a <ruleref> tag that imbeds the definition of another rule within the current rule.

To allow for easy construction of the surface semantic output, <output> tags are provided within each rule. When a rule matches, also known as firing, the tags and tagged values within the <output> tags are placed as the surface semantic output. Under one embodiment, extensible style-sheet language (XSL) tags found within the <output> tags are evaluated in a recursive fashion as part of constructing the surface semantic output. In particular, <xsl:apply-template> tags are executed to locate output surface semantics that are defined in a rule that is embedded in the current rule. For example, for the linguistic grammar:

### EXAMPLE 1

<rule name=“city”>

<list>

<p pron=“ny”> new york

<output>

<city>NYC</city>
<state>NY</state>
<country>USA</country>

</output>

</p>
<p pron=“sf”> san francisco

<output>

<city> SFO </city>
<state>CA</state>
<country>USA</country>

</output>

</p>

...

</list>

</rule>
<rule name=“itin”>

<list>

<p> from <ruleref name=“city”

propname=“orig”/>

to <ruleref name=“city”

propname=“dest”/>

</p>
<p> to <ruleref name=“city” propname=“dest”/>

from <ruleref name=“city”

propname=“orig”/>

</p>

</list>
<output>

<itinerary>

<xsl:attribute name=“text”>

<xsl:value-of/>

</xsl:attribute>
<destination>

<xsl:apply-template select=“dest”/>

</destination>
<origin>

<xsl:apply-template select=“orig”/>

</origin>

</itinerary>

</output>

</rule>

the tag <xsl:apply-template select=“dest”/> is evaluated by locating a rule that fired and that had a propname attribute of “dest” in its ruleref tag. The output tags located in the portion of the embedded rule that fired are then inserted in place of the apply-template tag. Thus, when the text “from San Francisco to New York” is applied to the linguistic grammar of Example 1, the following surface semantic is created:

<itinerary text=“from San Francisco to New York”>

<destination>

<city>NYC</city>
<state>NY</state>
<country>USA</country>

</destination>
<origin>

<city>SFO</city>
<state>CA</state>
<country>USA</country>

</origin>

</itinerary>

The tags within the surface semantic output can also include one or more attributes including a confidence attribute that indicates the confidence of the semantic structure marked by the tags. Thus, in the example above, the <origin> tag could be modified to <origin confidence=“90”> to indicate that the confidence of the city, state and country located between the tags is ninety percent. In addition, the output tags can include directions to place a name attribute in the tag in which the xsl:applytemplate tag is found.

The surface semantics produced by surface semantic parsers 206, 208 are provided to a context manager 214, which uses the surface semantics to build a discourse semantic structure at step 304 of FIG. 3.

When context manager 214 receives the surface semantics from parsers 206, 208, it uses the surface semantics to instantiate and/or expand a discourse semantic structure defined in a discourse grammar 216. Under one embodiment, discourse semantic definitions in discourse grammar 216 are generated by one or more applications 240. For example, an e-mail application may provide one set of discourse semantic definitions and a contacts application may provide a different set of discourse semantic definitions.

Under one embodiment, discourse semantic structures are defined using a tagged language. Two outer tags, <command> and <entity>, are provided that can be used to designate the discourse semantic as either a command or an entity. Both of these tags have a “type” attribute and an optional “name” attribute. The “type” attribute is used to set the class for the entity or command. For example, an entity can have a “type” of “PERSON”. Note that multiple entities and commands can be of the same type.

Ideally, the “name” for a command or entity is unique. Under one embodiment, a hierarchical naming structure is used with the first part of the name representing the application that defined the discourse semantic structure. For example, a discourse semantic structure associated with sending an e-mail and constructed by an e-mail program could be named “OutlookMail:sendmail”. This creates multiple name spaces allowing applications the freedom to designate the names of their semantic structures without concern for possible naming conflicts.

If an entity has a type specified but does not have a name specified, the type is used as the name. In most embodiments, if the type is used as the name, the type must be unique.

Between the <entity> or <command> tags are one or more <slot> tags that define the type and name of entities that are needed to resolve the <entity> or <command>. An<expert> tag is also provided that provides the address of a program that uses the values in the slot to try to resolve the <entity> or <command>. Such programs are shown as domain experts 222 in FIG. 2 and are typically provided by the application that defines the discourse semantic. In other embodiments, however, the domain expert is separate from the application and is called as a service.

An example of a semantic definition for a discourse semantic is:

### EXAMPLE 2

<entity type=“Bookit:itin”>

<slot type=“citylocation”

name=“bookit:destination”/>

<slot type=“citylocation”

name=“bookit:origin”/>

<slot type=“date_time”

name=“bookit:traveldate”/>

<expert>www.bookit.com/itinresolve.asp
</expert>

| </entity> | |
|---|---|
| <entity | type=“citylocation” |

name=“contact:locationbyperson”>

<slot type=“person”

name=“contact:person”/>

<expert>

www.contact.com/locatebyperson.asp

</expert>

</entity>

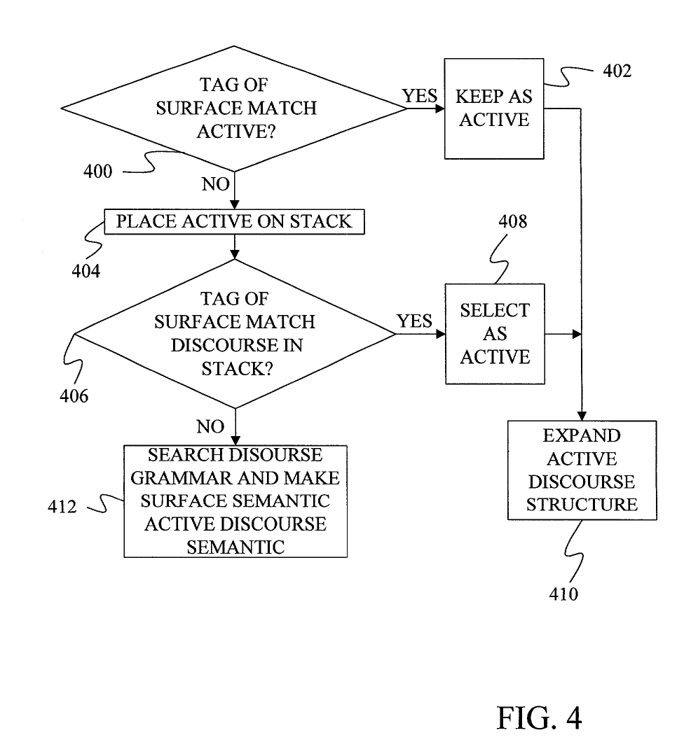

FIG. 4 provides a flow diagram for expanding and instantiating discourse semantic structures based on the surface semantic. When the surface semantic is provided to context manager 214, the top tag in the surface semantic is examined to determine if a discourse semantic structure has already been started for the surface semantic. This would occur if the system were in the middle of a dialogue and a discourse semantic structure had been started but could not be completely resolved. Under one embodiment, multiple partially filled discourse semantic structures can be present at the same time. The discourse semantic structure that was last used to pose a question to the user is considered the active discourse semantic structure. The other partially filled discourse semantic structures are stored in a stack in discourse memory 218 and are ordered based on the last time they were expanded.

Thus, at step 400, context manager 214 first compares the outer tag of the surface semantic to the semantic definitions of the active discourse semantic structure to determine if the tag should replace an existing tag in the active discourse semantic structure or if the tag can be placed in an unfilled slot of the active discourse semantic structure. Under most embodiments, this determination is made by comparing the tag to the type or to the name and type of an existing tag in the active structure and any unfilled slots in the active discourse semantic structure. If there is a matching tag or unfilled slot, the active discourse semantic structure remains active at step 402. If the tags do not match any existing tags or an unfilled slot, the active discourse semantic structure is placed on the stack at step 404 and the discourse semantic structures on the stack are examined to determine if any of them have a matching tag or matching unfilled slot. If there is a tag or unfilled slot in one of the discourse semantic structures in discourse memory 218 that matches the surface semantics at step 406, the matching discourse semantic structure is made the active discourse semantic structure at step 408.

The active discourse semantic structure is then updated at step 410 using the current surface semantic. First, tags that satisfy unfilled slots are transferred from the surface semantic into the discourse semantic structure at a location set by the discourse semantic definition. Second, the tags in the surface semantic that match existing tags in the discourse semantic structure are written over the identically named tags in the discourse semantic structure.

If a matching discourse semantic structure cannot be found in the discourse memory at step 406, the surface semantic becomes the discourse semantic structure at step 412.

After an active discourse semantic structure has been instantiated or expanded at step 304, the context manager attempts to resolve entities at step 305. For example, the input “I want to fly to Bill's from Tulsa, Okla. on Saturday at 9” produces the following discourse semantic:

### EXAMPLE 3

<Bookit:itin>

<bookit:destination type=“citylocation”

name=“contact:locationbyperson”>

<person>Bill</person>

</bookit:destination>
<bookit:origin>Tulsa,OK</bookit:origin>
<bookit:date_time>

<Date>Saturday</Date>
<Time>9:00</Time>

</bookit:date_time>

</Bookit:itin>

Based on this discourse semantic, the context manager tries to resolve ambiguous references in the surface semantics, using dialog history or other input modalities. In the above example, the reference to a person named “Bill” might be ambiguous on its own. However, if it is clear from the dialog context that “Bill” here refers to a specific person mentioned in the previous turn, the context manager can resolve the ambiguity (known as ellipsis reference in linguistic literature) into a concrete entity by inserting additional information, e.g., the last name “Smith”. Similarly, the date reference “Saturday” may be ambiguous on its own. However, if from the context it is clear that the Saturday mentioned in the current utterance is “12/01/02”, the context manager can simply resolve this date reference by replacing “Saturday” with “12/01/02”. Note that these insertions and/or replacements are subject to further verification by the domain experts as explained later.

In the example above, if “Bill” could not be resolved but Saturday could, step 305 would produce the discourse semantic structure:

<Bookit:itin>

<bookit:destination
type=“citylocation”
name=“contact:locationbyperson”>

<person>Bill
</person>

</bookit:destination>
<bookit:origin>Tulsa,OK</bookit:origin>
<bookit:date_time>12/01/02:9:00
</bookit:date_time>

</Bookit:itin>

Once the active discourse structure has been partially resolved, if possible, at step 305, domain experts are invoked at step 306 to further resolve entities in the active discourse structure. Under one embodiment, domain experts associated with inner-most tags (the leaf nodes) of the discourse semantic structure are invoked first in the order of the slots defined for each entity. Thus, in the example above, the domain expert for the contact:locationbyperson entity would be invoked first.

The call to the domain expert has three arguments: a reference to the node of the <entity> or <command> tag that listed the domain expert, a reference to entity memories in discourse memory 218, and an integer indicating the outcome of the domain expert (either successful resolution or ambiguity).

Under one embodiment, the reference to the entity memory is a reference to a stack of entities that have been explicitly or implicitly determined in the past and that have the same type as one of the slots used by the domain expert. Each stack is ordered based on the last time the entity was referenced. In addition, in some embodiments, each entity in the stack has an associated likelihood that indicates the likelihood that the user may be referring to the entity even though the user has not explicitly referenced the entity in the current discourse structure. This likelihood decays over time such that as more time passes, it becomes less likely that the user is referring to the entity in memory. After some period of time, the likelihood becomes so low that the entity is simply removed from the discourse memory.

Under the present invention, discourse memory 218 also includes anti-entity stacks. The anti-entity stacks are similar to the entity stacks except they hold entities that the user has explicitly or implicitly excluded from consideration in the past. Thus, if the user has explicitly excluded the name Joe Smith, the “Person” anti-entity stack will contain Joe Smith.

Like the entity stack, the anti-entity stack decays over time by applying a decaying likelihood attribute to the anti-entity. This likelihood can be provided as a negative number such that if an entity appears in both the entity stack and the anti-entity stack, the likelihoods can be added together to determine if the entity should be excluded from consideration or included as an option.

Entities in the anti-entity stack can be removed when their confidence level returns to zero or if the user explicitly asks for the entity to be considered.

The entity memory allows the domain expert to resolve values that are referred to indirectly in the current input from the user. This includes resolving indirect references such as deixis (where an item takes its meaning from a preceding word or phrase), ellipsis (where an item is missing but can be naturally inferred), and anaphora (where an item is identified by using definite articles or pronouns) Examples of such implicit references include statements such as “Send it to Jack”, where “it” is an anaphora that can be resolved by looking for earlier references to items that can be sent or “Send the message to his manager” where “his manager” is a deixis that is resolved by determining first who the pronoun “his” refers to and then using the result to look for the manager in the database.

The domain expert also uses the anti-entity stacks to resolve nodes. In particular, the domain expert reduces the likelihood that a user was referring to an entity if the entity is present in the anti-entity stack.

This reduction in likelihood can occur in a number of ways. First, the confidence score provided for the entity in the surface semantic can be combined with the negative likelihood for the entity in the anti-entity stack. The resulting combined likelihood can then be compared to some threshold, such as zero. If the likelihood is below the threshold, the domain expert will not consider the entity as having been referenced in the user's input.

Alternatively or in combination with the technique above, a likelihood for the entity in the entity stack is combined with the negative likelihood for the entity in the anti-entity stack to produce the reduced likelihood for the entity. This reduced likelihood is then compared to the threshold.

As a result of not considering entities with a reduced likelihood, the domain expert is able to resolve a node if there were only two options for the node and one of the options had a reduced likelihood below the threshold. If there are more than two options, the domain expert is able to ignore options with reduced likelihoods below the threshold and as a result avoid presenting the user with options they have already excluded.

Using the contents found between the tags associated with the domain expert and the values in the discourse memory, the domain expert attempts to identify a single entity or command that can be placed between the tags. If the domain expert is able to resolve the information into a single entity or command, it updates the discourse semantic structure by inserting the entity or command between the <entity> or <command> tags in place of the other information that had been between those tags.

If the domain expert cannot resolve the information into a single entity or command, it updates the discourse semantic structure to indicate there is an ambiguity. If possible, the domain experts update the discourse semantic structure by listing the possible alternatives that could satisfy the information given thus far. For example, if the domain expert for the contact:locationbyperson entity determines that there are three people named Bill in the contact list, it can update the discourse semantic structure as:

<Bookit:itin>

<bookit:destination type=“citylocation”

name=“contact:locationbyperson”>

<person alternative=“3”>

<choice>

Bill Bailey

</choice>
<choice>

Bill Parsens

</choice>
<choice>

Bill Smith

</choice>

</person>

</bookit:destination>
<bookit:origin>Tulsa,OK</bookit:origin>
<bookit:date_time>12/01/02:9:00
</bookit:date_time>

</Bookit:itin>

The domain expert also updates the entity memory of discourse memory 218 if the user has made an explicit reference to an entity or if the domain expert has been able to resolve an implicit reference to an entity.

In addition, at step 308, the domain expert determines if an entity has been excluded by the user. For example, if the user asks to book a flight from “Bill's house to Florida” and the dialog system determines that there are a number of people named Bill, it may ask if the user meant “Bill Smith”. If the user says “No”, the domain expert can use that information to set an anti-entity value for the entity “Bill Smith” at step 310. Under one embodiment, setting the anti-entity value involves placing the entity in the anti-entity stack. In other embodiments, setting an anti-entity value involves changing the discourse semantic structure to trigger a change in the linguistic grammar as discussed further below or directly changing the linguistic grammar.

If the domain expert cannot resolve its entity or command, the discourse semantic structure is used to generate a response to the user. In one embodiment, the discourse semantic structure is provided to a planner 232, which applies a dialog strategy to the discourse semantic structure to form a dialog move at step 312. The dialog move provides a device-independent and input-independent description of the output to be provided to the user to resolve the incomplete entity. By making the dialog move device-independent and input-independent, the dialog move author does not need to understand the details of individual devices or the nuances of user-interaction. In addition, the dialog moves do not have to be re-written to support new devices or new types of user interaction.

Under one embodiment, the dialog move is an XML document. As a result, the dialog strategy can take the form of an XML style sheet, which transforms the XML of the discourse semantic structure into the XML of the dialog move. For clarity, the extension of XML used as the dialog moves is referred to herein as DML.

Under most embodiments of the present invention, the dialog strategy is provided to context manager 214 by the same application that provides the discourse semantic definition for the node being used to generate the response to the user.

The dialog moves are provided to a generator 224, which generates the physical response to the user and prepares the dialog system to receive the next input from the user at step 314. The conversion from dialog moves to response is based on one or more behavior templates 226, which define the type of response to be provided to the user, and the actions that should be taken to prepare the system for the user's response. Under one embodiment, the behavior templates are defined by the same application 240 that defined the discourse semantic structure.

Under the present invention, preparing for the user's response can include priming the system by altering the linguistic grammar so that items previously excluded by the user are not returned in the surface semantics or if returned are given a lower confidence level. By altering the linguistic grammar in this manner, the domain experts are less likely to consider the excluded items as being a choice when resolving the semantic node.

To indicate that the linguistic grammar should be modified to limit the return of certain values in the surface semantic, the domain experts set an anti-entity value in the discourse semantic structure. For example, the domain expert can list the entity between <choice> tags with a negative confidence attribute. Under one embodiment, based on the anti-entity value placed in the discourse semantic structure, planner 232 inserts a <disallow> tag in the dialog moves. For example, to alter the linguistic grammar to limit the likelihood that “Joe Smith” will be considered in the next turn by the domain experts, the following dialog moves can be created:

<dml>

<ask style=“list”

type=“contact:person”/>

<disallow slot=“person”

name=“contact:locationbyperson”>
<choice>Joe Smith</choice>

</disallow>

</dml>

This dialog move includes an <ask> tag that indicates that the user should be provided with a list of names and that the system should alter the linguistic grammar so that Joe Smith is not returned or if it is returned is given a lowered confidence level.

The linguistic grammar can be altered in two different ways to lower the confidence level for an anti-entity. The first way is to alter the matching portion of the grammar so that the anti-entity cannot be matched to the input. The second way is to alter the surface semantic output portion of the linguistic grammar so that even if matched, the anti-entity is not returned or if it is returned, is returned with a low confidence level. For example, the output portion of a linguistic grammar can be altered to exclude Joe Smith in the following way:

<rule name=“contact:selectname”>

<ruleref name=“names” propname=“person”/>

<output name=“Bookit:itin”>

<bookit:destination
type=“citylocation”
name=“contact:locationbyperson”>
<xsl:applytemplate select=“person”/>

<person confidence=“impossible”>

Joe Smith

</person>

</bookit:destination>

</output>

</rule>

If “Joe Smith” is matched by the “names” rule, the following surface semantic would be produced from the linguistic grammar above:

<Bookit:itin>

<bookit:destination

type=“citylocation”
name=“contact:locationbyperson”>
<person alternatives=“2”>

<choice confidence=“60”>

Joe Smith

</choice>
<choice confidence=“30”>

Joe Parsens

</choice>

</person>
<person confidence=“impossible”>

Joe Smith

</person>

</bookit:destination>

</Bookit:itin>

When this surface semantic is converted into a discourse semantic and the discourse semantic is provided to the domain expert, the domain expert is able to rule out “Joe Smith” even though it was initially recognized with a higher confidence than “Joe Parsens”. The reason for this is the additional set of tags for “Joe Smith” that reset the confidence level to “impossible”.

The confidence level does not have to be set to impossible but instead could be set to some low value. This allows the anti-entity to be selected by the domain expert if all other possible inputs are at an even lower confidence level.

Thus, the present invention is able to create anti-entities that reduce the likelihood that the domain expert will consider an entity as being an option for resolving an ambiguous input if the user has previously excluded the entity. At times, this allows the domain expert to resolve the entity by ruling out the anti-entity values. In other cases, the domain expert may not be able to resolve the entity but will not provide the anti-entity as a choice to the user. As a result, the user will not be repeatedly asked if they want the anti-entity when they have made it clear in the past that they do not want that entity.

The behavioral templates can include code for calculating the cost of various types of actions that can be taken based on the dialog moves. The cost of different actions can be calculated based on several different factors. For example, since the usability of a dialog system is based in part on the number of questions asked of the user, one cost associated with a dialog strategy is the number of questions that it will ask. Thus, an action that involves asking a series of questions has a higher cost than an action that asks a single question.

A second cost associated with dialog strategies is the likelihood that the user will not respond properly to the question posed to them. This can occur if the user is asked for too much information in a single question or is asked a question that is too broadly worded.

Lastly, the action must be appropriate for the available output user interface. Thus, an action that would provide multiple selections to the user would have a high cost when the output interface is a phone because the user must memorize the options when they are presented but would have a low cost when the output interface is a browser because the user can see all of the options at once and refer to them several times before making a selection.

The domain expert can also take the cost of various actions into consideration when determining whether to resolve an entity. For example, if the domain expert has identified two possible choices for an entity, with one choice having a significantly higher confidence level, the domain expert may decide that the cost of asking the user for clarification is higher than the cost of selecting the entity with the higher score. As a result, the domain expert will resolve the entity and update the discourse semantic structure accordingly.

Although the present invention has been described with reference to preferred embodiments, workers skilled in the art will recognize that changes may be made in form and detail without departing from the spirit and scope of the invention. In particular, although the invention has been described above with reference to XML-based tagged languages, the data constructs may be formed using any of a variety of known formats including tree structures.

In addition, although the invention has been described above in the context of a dialog system, the invention is not limited to such systems. The setting of anti-entity values and the use of such values to clarify input may be used in any system where the input is ambiguous.

What is claimed is:

1. A method of interacting with a user on a computer system, the method comprising:
interacting with the user to identify an entity that the user does not want;
setting an anti-entity value based on the identified entity;
using the anti-entity value to clarify ambiguous input from the user by reducing a likelihood that the entity represented by the anti-entity value will be considered as having been referenced in the ambiguous input.

2. The method of claim 1 wherein setting an anti-entity value comprises storing the entity in an anti-entity memory.

3. The method of claim 2 wherein setting an anti-entity value further comprises setting a likelihood value for the entity in the anti-entity memory.

4. The method of claim 3 wherein the likelihood value is a negative value.

5. The method of claim 4 further comprising changing the likelihood value over time so that the likelihood value moves toward zero.

6. The method of claim 5 further comprising removing the entity from the anti-entity memory when the likelihood value reaches zero.

7. The method of claim 2 further comprising:
receiving input from the user indicating there is a high likelihood that the user wishes to consider the entity in the anti-entity memory; and
removing the entity from the anti-entity memory in response to the input.

8. The method of claim 2 wherein using the anti-entity value comprises:
identifying at least two possible entities that could be referenced by the ambiguous input;
determining that one of the two possible entities has an entry in the anti-entity memory; and
using the entry in the anti-entity memory to reduce the likelihood that the entity in the entry was referenced in the ambiguous input.

9. The method of claim 8 wherein using the entry in the anti-entity memory comprises reducing the likelihood to zero.

10. The method of claim 1 wherein setting an anti-entity value comprises setting a value that causes a change in a linguistic grammar used to form a surface semantic from the ambiguous input.

11. The method of claim 10 wherein changing the linguistic grammar comprises setting a surface semantic output value in the linguistic grammar.

12. The method of claim 11 wherein setting a surface semantic output value comprises setting a confidence level for the entity.

13. The method of claim 12 wherein setting the confidence level comprises setting the confidence level to zero.

14. The method of claim 10 wherein changing the linguistic grammar comprises adjusting a matching portion of the linguistic grammar such that the anti-entity is not matched to the ambiguous input.

15. A computer-readable medium having computer-executable instructions for performing steps comprising:
receiving an indication that a user wants to exclude an item from consideration;
setting a value to reduce the likelihood that ambiguous input is interpreted as including a reference to the item;
providing a response to the user;
after providing the response, receiving ambiguous input that can be interpreted as having a reference to the item; and
accessing the value to determine how to interpret the ambiguous input.

16. The computer-readable medium of claim 15 wherein setting a value comprises setting a value in memory and wherein accessing the value comprises accessing the value in memory.

17. The computer-readable medium of claim 16 wherein setting a value further comprises setting the item and a likelihood value for the item in memory.

18. The computer-readable medium of claim 17 wherein setting a likelihood value comprises setting a negative value for the likelihood.

19. The computer-readable medium of claim 17 further comprising changing the likelihood value over time such that it becomes more likely that ambiguous input will be interpreted as including a reference to the item.

20. The computer-readable medium of claim 19 further comprising removing the item and the likelihood value from the memory when the likelihood value no longer reduces the likelihood that ambiguous input is interpreted as including a reference to the item.

21. The computer-readable medium of claim 16 further comprising removing the value from memory if the user explicitly includes the item.

22. The computer-readable medium of claim 16 further comprising removing the value from the memory after a period of time.

23. The computer-readable medium of claim 15 wherein setting a value comprises setting a value in a grammar used to convert user input into a semantic structure.

24. The computer-readable medium of claim 23 wherein setting a value in a grammar comprises defining a matching portion of the grammar such that the item cannot be matched to a user input.

25. The computer-readable medium of claim 23 wherein setting a value in a grammar comprises defining an output portion of the grammar such that the item is returned with a reduced confidence.
